(19) United States
(12) Patent Application Publication
(10) Pub. No.: US 2020/0053186 A1
(43) Pub. Date: Feb. 13, 2020

(54) COMMUNICATION TERMINAL, COMMUNICATION METHOD, AND RECORDING MEDIUM

(71) Applicant: OLYMPUS CORPORATION, Tokyo (JP)

(72) Inventor: Ryuichi Kiyoshige, Tokyo (JP)

(21) Appl. No.: 16/655,654

(22) Filed: Oct. 17, 2019

Related U.S. Application Data
(63) Continuation of application No. PCT/JP2017/016321, filed on Apr. 25, 2017.

(51) Int. Cl. H04L 29/08; H04L 29/12; H04L 29/06; H04W 48/20; H04L 9/08; H04W 12/00

(52) U.S. Cl. CPC H04L 67/32; H04L 61/2007; H04L 67/1097; H04W 84/12; H04W 48/20; H04L 9/0894; H04W 12/0013; H04L 69/03

(57) ABSTRACT

In a communication terminal, a storage medium is configured to store service information including first to fourth information associated with each other. A controller is configured to acquire fifth to seventh information when a service request including use information is generated from the application. The controller is configured to determine whether or not the fifth information matches the second information, the sixth information matches the third information, and the seventh information matches the fourth information. The controller is configured to connect to the access point represented by the first information associated with the second information, the third information, and the fourth information matching the fifth information, the sixth information, and the seventh information, respectively, acquired on the basis of the use information by using the communicator.

The present application is a continuation application based on International Patent Application No. PCT/JP2017/016321 filed on Apr. 25, 2017, the content of which is incorporated herein by reference.

### BACKGROUND OF THE INVENTION

### Field of the Invention

The present invention relates to a communication terminal, a communication method, and a recording medium.

### Description of Related Art

Due to diffusion of a wireless local area network (LAN), opportunities to use the wireless LAN in offices, homes, and the like have been increasing. In general, there are many cases where an access point is installed on a network and the wireless LAN is provided as infrastructure for accessing a local server and the Internet from a client terminal. In these cases, only one network is installed. For example, even when a plurality of access points are installed in an office or the like, all the access points are installed on the identical network.

On the other hand, there are cases where each of a plurality of access points is installed on each of networks independent of each other such that areas covered by radio waves of access points overlap each other. For example, main infrastructure capable of accessing an external network such as the Internet and accessing a server or the like is installed inside a hospital. When a new client-server-type diagnosis apparatus or the like using the wireless LAN is introduced, there are cases where a local network independent of main infrastructure is installed in consideration of influences on the main infrastructure and convenience.

Doctors and nurses connect a client terminal to main infrastructure or a local network inside a hospital in accordance with a purpose. Since Doctors and nurses need to manually switch connection destinations in accordance with a purpose every time, it is very troublesome. For example, a device such as a personal computer and a smart phone has a function of automatically connecting to an access point that has been accessed by the device.

The function enables the device to scan access points around the device and thereafter try to connect to an access point detected first among access points that have been accessed by the device before. For this reason, the device may connect to an access point that is unable to access a network including a service that doctors and nurses desire to receive. It is difficult for doctors and nurses to be aware of the network that is currently connected to by the device. Alternatively, it is difficult for doctors and nurses to understand a network configuration. For this reason, doctors and nurses worry about the trouble that it is impossible to use the target service for some reason or the like, although a client terminal is apparently connected to a network.

In Japanese Unexamined Patent Application, First Publication No. 2015-130591, an apparatus and a method in environment in which there are a plurality of access points that can be connected to are disclosed. The apparatus and the method disclosed in Japanese Unexamined Patent Application, First Publication No. 2015-130591 are able to switch access points that are wirelessly connected to on the basis of the priority order set in an application that is used and the amount of communication data in the past.

### SUMMARY OF THE INVENTION

According to a first aspect of the present invention, a communication terminal includes a storage medium, a communicator, and a controller. The storage medium is configured to store service information regarding a service provided by a service providing terminal disposed in each network included in a plurality of networks. The service information includes first information, second information, third information, and fourth information associated with each other. The first information is configured to identify an access point connected to by the communicator at a time of communication for an application to use the service. The second information is configured to identify the application. The third information represents an IP address of the service providing terminal. The fourth information is configured to identify a protocol for using the service. The controller is configured to execute information acquisition processing of acquiring fifth information that is configured to identify the application, sixth information that represents the IP address, and seventh information that is configured to identify the protocol on the basis of the use information when a service request including use information for using the service is generated from the application. The controller is configured to execute determination processing of determining whether or not the fifth information matches the second information, determining whether or not the sixth information matches the third information, and determining whether or not the seventh information matches the fourth information. The controller is configured to connect to the access point represented by the first information associated with the second information, the third information, and the fourth information matching the fifth information, the sixth information, and the seventh information, respectively, acquired on the basis of the use information by using the communicator.

According to a second aspect of the present invention, in the first aspect, the storage medium may be configured to store an encryption key used when the communicator connects to the access point identified by the first information included in the service information. The controller may be configured to encrypt the service information by using the encryption key. The controller is configured to transmit the encrypted service information to an external terminal different from the communication terminal by using the communicator.

According to a third aspect of the present invention, in the first aspect, when a new service request including the use information is generated from the application in a state in which communication connection between a first access point represented by the first information and the communicator is sustained, the controller may be configured to execute the information acquisition processing on the basis of the use information included in the new service request. The controller may be configured to execute the determination processing regarding information acquired on the basis of the use information included in the new service request. The controller may be configured to disconnect the communication connection between the first access point and the communicator when the first access point is different from a second access point represented by the first information associated with the second information, the third information, and the fourth information matching the fifth information, the sixth information, and the seventh information, respectively, acquired on the basis of the use information included in the new service request. When each of pieces of the information acquired on the basis of the use information included in the new service request matches corresponding information included in the service information, the controller may be configured to connect to the second access point by using the communicator after the communication connection between the first access point and the communicator is disconnected.

According to a fourth aspect of the present invention, in the first aspect, the controller may be configured to output a temporary response data for the service request to the application before communication with the service providing terminal through the access point is started. The controller may be configured to output data received from the service providing terminal to the application after the communication with the service providing terminal through the access point is started.

According to a fifth aspect of the present invention, in the first aspect, the controller may be configured to acquire a communication result regarding communication with the service providing terminal after the communication with the service providing terminal through the access point is started. The controller may be configured to associate communication result information that represents the communication result with the service information and record the communication result information on the storage medium when the communication result represents failure of the communication. When a new service request including the use information is generated from the application, the controller may be configured to execute the information acquisition processing on the basis of the use information included in the new service request. The controller may be configured to execute the determination processing regarding information acquired on the basis of the use information included in the new service request. The controller may be configured to connect to the access point represented by the first information included in the service information that includes information matching each of pieces of the information acquired on the basis of the use information and is not associated with the communication result information representing failure of the communication by using the communicator.

According to a sixth aspect of the present invention, in the fifth aspect, the controller may be configured to output response data that represents that communication is impossible to the application when the communication result information representing the failure of the communication is associated with all of pieces of the service information including information matching each of pieces of the information acquired on the basis of the use information.

According to a seventh aspect of the present invention, in the fifth aspect, the controller may be configured to connect to the access point represented by the first information associated with the second information matching the fifth information and associated with the fourth information matching the seventh information by using the communicator when there is no service information including information matching each of pieces of the information acquired on the basis of the use information.

According to an eighth aspect of the present invention, in the first aspect, the controller may be configured to acquire a communication result regarding communication with the service providing terminal after the communication with the service providing terminal through the access point is started. The controller may be configured to associate communication result information that represents the communication result with the service information and record the communication result information on the storage medium when the communication result represents success of the communication. When a new service request including the use information is generated from the application, the controller may be configured to execute the information acquisition processing on the basis of the use information included in the new service request. The controller may be configured to execute the determination processing regarding information acquired on the basis of the use information included in the new service request. The controller may be configured to connect to the access point represented by the first information included in the service information that includes information matching each of pieces of the information acquired on the basis of the use information and is associated with the communication result information representing success of the communication by using the communicator.

According to a ninth aspect of the present invention, a communication method uses service information and includes an information acquisition step, a determination step, and a communication connection step. The service information relates to a service provided by a service providing terminal disposed in each network included in a plurality of networks. The service information includes first information, second information, third information, and fourth information associated with each other. The first information is configured to identify an access point connected to by a communicator at a time of communication for an application to use the service. The second information is configured to identify the application. The third information represents an IP address of the service providing terminal. The fourth information is configured to identify a protocol for using the service. A controller acquires fifth information that is configured to identify the application, sixth information that represents the IP address, and seventh information that is configured to identify the protocol on the basis of use information for using the service in an information acquisition step when a service request including the use information is generated from the application. The controller determines whether or not the fifth information matches the second information, determines whether or not the sixth information matches the third information, and determines whether or not the seventh information matches the fourth information in a determination step. The communicator connects to the access point represented by the first information associated with the second information, the third information, and the fourth information matching the fifth information, the sixth information, and the seventh information, respectively, acquired on the basis of the use information in a communication connection step.

According to a tenth aspect of the present invention, a non-transitory computer-readable recording medium saving a program for causing a computer to use service information is provided. The service information relates to a service provided by a service providing terminal disposed in each network included in a plurality of networks. The service information includes first information, second information, third information, and fourth information associated with each other. The first information is configured to identify an access point connected to by a communicator at a time of communication for an application to use the service. The second information is configured to identify the application. The third information represents an IP address of the service providing terminal. The fourth information is configured to identify a protocol for using the service. The program causes the computer to execute an information acquisition step, a determination step, and a communication connection step. The computer acquires fifth information that is configured to identify the application, sixth information that represents the IP address, and seventh information that is configured to identify the protocol on the basis of use information for using the service in the information acquisition step when a service request including the use information is generated from the application. The computer determines whether or not the fifth information matches the second information, determines whether or not the sixth information matches the third information, and determines whether or not the seventh information matches the fourth information in the determination step. The computer causes the communicator to connect to the access point represented by the first information associated with the second information, the third information, and the fourth information matching the fifth information, the sixth information, and the seventh information, respectively, acquired on the basis of the use information in the communication connection step.

### BRIEF DESCRIPTION OF THE DRAWINGS

FIG. 1 is a block diagram showing a configuration of a communication system according to an embodiment of the present invention.

FIG. 2 is a block diagram showing a configuration of an STA according to the embodiment of the present invention.

FIG. 3 is a diagram showing a communication sequence in the embodiment of the present invention.

FIG. 4 is a flow chart showing processing executed by the STA according to the embodiment of the present invention.

FIG. 5 is a schematic diagram showing a configuration of a packet flame in the embodiment of the present invention.

FIG. 6 is a flow chart showing processing executed by the STA according to the embodiment of the present invention.

FIG. 7 is a reference diagram showing a table in which relationships between a destination port number, a protocol type, and an application type in the embodiment of the present invention are defined.

FIG. 8 is a reference diagram showing contents of a temporary response message in the embodiment of the present invention.

FIG. 9 is a reference diagram showing contents of learning data in the embodiment of the present invention.

FIG. 10 is a flow chart showing processing executed by the STA according to the embodiment of the present invention.

FIG. 11 is a flow chart showing processing executed by the STA according to the embodiment of the present invention.

FIG. 12 is a reference diagram showing contents of a response message in the embodiment of the present invention.

FIG. 13 is a flow chart showing processing executed by the STA according to the embodiment of the present invention.

FIG. 14 is a reference diagram showing contents of a response message in the embodiment of the present invention.

FIG. 15 is a flow chart showing processing executed by the STA according to the embodiment of the present invention.

FIG. 16 is a reference diagram showing contents of learning data in the embodiment of the present invention.

FIG. 17 is a reference diagram showing contents of learning data in the embodiment of the present invention.

FIG. 18 is a flow chart showing processing executed by the STA according to the embodiment of the present invention.

FIG. 19 is a flow chart showing processing executed by the STA according to the embodiment of the present invention.

### DETAILED DESCRIPTION OF THE INVENTION

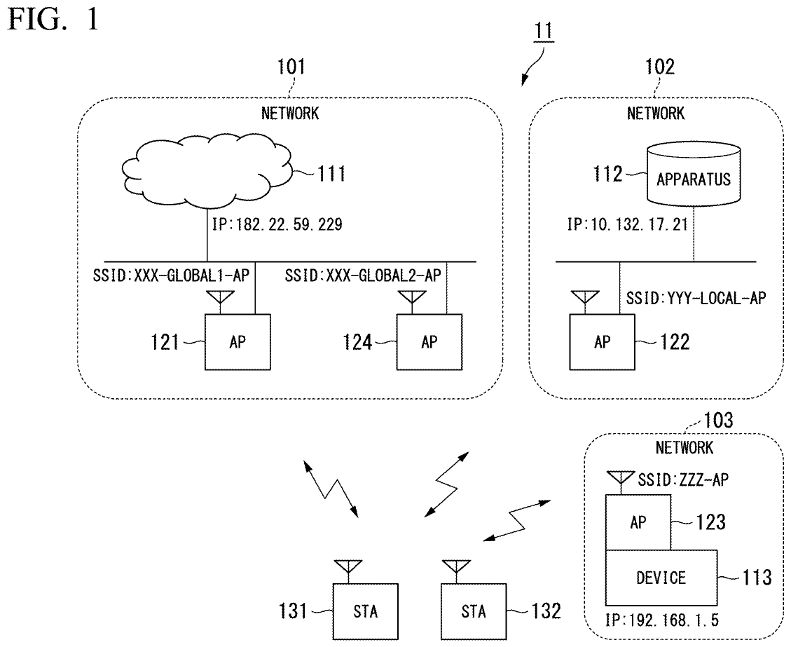

Hereinafter, embodiments of the present invention will be described with reference to the drawings. FIG. 1 shows a configuration of a communication system 11 according to an embodiment of the present invention. As shown in FIG. 1, the communication system 11 includes a network 101, a network 102, a network 103, an STA 131, and an STA 132.

The network 101, the network 102, and the network 103 constitute independent networks. There exists no communication path through which a device of one network and a device of another network can access each other. An access point 121 and an access point 124 are included in the network 101. The access point 121 and the access point 124 are connected to a terminal of a cloud 111 on the Internet.

Different frequency channels are set to the access point 121 and the access point 124. The access point 121 and the access point 124 are properly used in accordance with purposes. Alternatively, the access point 121 and the access point 124 are installed in order to distribute client terminals to prevent so many client terminals from concentrating to one access point.

An access point 122 and an apparatus 112 are included in the network 102. The network 103 consists of only a device 113 incorporating an access point 123.

The STA 131 and the STA 132 are communication terminals. Ranges covered by radio waves by the access points 121 to 124 included in the networks 101 to 103 overlap each other. The STA 131 and the STA 132 are present at a position reached by radio waves from any access point. Therefore, the STA 131 and the STA 132 are in a state in which they can connect to any access point.

A terminal of the cloud 111 of the network 101, the apparatus 112 of the network 102, and the device 113 of the network 103 have a function of providing a service to the STA 131 and the STA 132. In other words, the terminal of the cloud 111, the apparatus 112, and the device 113 are service providing terminals, i.e., servers. For example, the terminal of the cloud 111 provides an Internet web service. The apparatus 112 provides a service of performing setting of an apparatus and state-monitoring of an apparatus.

The device 113 provides a service of sharing data accumulated within a device.

Different pieces of network identification information (SSID) are given to respective access points included in each network. Each access point is able to be identified by the SSID. The STA 131 and the STA 132 select an access point that will become a communication path to a network including a service that an application desires to receive in accordance with a purpose and access the service through the access point.

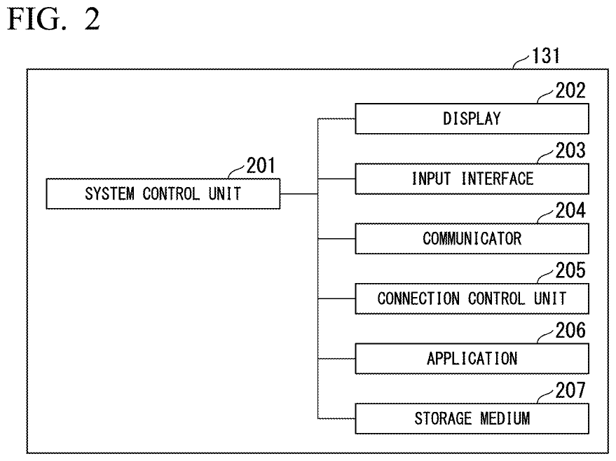

FIG. 2 shows a configuration of the STA 131 and the STA 132. Since the configurations of the STA 131 and the STA 132 are the same, the configuration of the STA 131 as a representative will be described below.

A schematic configuration of the STA 131 will be described. The STA 131 includes a storage medium 207, a communicator 204, and a connection control unit 205 (controller). The storage medium 207 stores service information regarding a service provided by a service providing terminal disposed in each network included in a plurality of networks. The service information includes first information, second information, third information, and fourth information associated with each other. The first information is configured to identify an access point connected to by the communicator 204 at a time of communication for an application 206 to use a service. The second information is configured to identify the application 206. The third information represents an IP address of a service providing terminal. The fourth information is configured to identify a protocol for using a service.

When a service request including use information for using a service is generated from the application 206, the connection control unit 205 executes information acquisition processing. The connection control unit 205 acquires fifth information that is configured to identify the application 206, sixth information that represents an IP address of a service providing terminal, and seventh information that is configured to identify a protocol on the basis of the use information in the information acquisition processing. The connection control unit 205 executes determination processing. The connection control unit 205 determines whether or not the fifth information matches the second information, determines whether or not the sixth information matches the third information, and determines whether or not the seventh information matches the fourth information in the determination processing. When each of pieces of the information acquired on the basis of the use information matches corresponding information included in the service information, the connection control unit 205 connects to an access point represented by the first information associated with the second information, the third information, and the fourth information matching the fifth information, the sixth information, and the seventh information, respectively, acquired on the basis of the use information by using the communicator 204.

A detailed configuration of the STA 131 will be described. The STA 131 includes a system control unit 201, a display 202, an input interface 203, the communicator 204, the connection control unit 205, the application 206, and the storage medium 207.

The system control unit 201 is constituted by at least one of a processor and a logic circuit. For example, the processor is at least one of a central processing unit (CPU), a digital signal processor (DSP), and a graphics processing unit (GPU). For example, the logic circuit is at least one of an application specific integrated circuit (ASIC) and a field-programmable gate array (FPGA). The system control unit 201 may include one or a plurality of processors. The system control unit 201 may include one or a plurality of logic circuits. The system control unit 201 controls the entire system.

For example, the display 202 is at least one of a liquid crystal display and an organic electro luminescence (EL) display. The display 202 may be a touch panel display. In such a case, the display 202 and the input interface 203 are integrated. The display 202 visually displays a state of the system, a message for urging a user to perform an operation, and the like.

For example, the input interface 203 is at least one of a button, a switch, a key, a mouse, a joystick, a touch pad, a track ball, and a touch panel. The input interface 203 converts intention of a user to a signal and transmits the signal to the system control unit 201.

The communicator 204 wirelessly connects to each access point and communicates with a service providing terminal through each access point. For example, an encryption algorithm for secure communication with an access point is implemented in the communicator 204. The communicator 204 receives an instruction from the connection control unit 205 and performs search for an access point and wireless connection to an instructed access point. The communicator 204 transmits and receives data that are transferred between the application 206 and a service providing terminal.

The connection control unit 205 is constituted by at least one of a processor and a logic circuit. The connection control unit 205 may include one or a plurality of processors. The connection control unit 205 may include one or a plurality of logic circuits. At least part of functions of the connection control unit 205 may be included in at least one of a processor and a logic circuit within the communicator 204.

The connection control unit 205 instructs the communicator 204 to search for a peripheral access point and wirelessly connect to a specific access point. The connection control unit 205 relays data between the application 206 and the communicator 204. Specifically, the connection control unit 205 always retains a local IP address. The connection control unit 205 presents this local IP address to the application 206 as an IP address of a terminal. A communication request that is a service request from the application 206 is transmitted to a network through the communicator 204. At this time, the connection control unit 205 rewrites a transmission source address included in the communication request from a local IP address to an IP address that is able to be accepted on a network to which a service providing terminal that provides the desired service belongs. A communication response returned from the desired service on the network is passed on from the communicator 204 to the application 206. At this time, the connection control unit 205 rewrites a destination address included in the communication response to a local IP address. The connection control unit 205 generates a response message to the application 206 in accordance with a situation and outputs the generated response message to the application 206. In this way, the connection control unit 205 notifies the application 206 of the response message.

The connection control unit 205 analyzes a communication request from the application 206. The connection control unit 205 records a combination as learning data (service information) on the storage medium 207. The combination includes various pieces of information included in the communication request, a communication result when a connection to a service providing terminal is tried, and information of an access point that belongs to a network including a service that satisfies the communication request. The connection control unit 205 collates various pieces of information included in the communication request from the application 206 with the learning data recorded on the storage medium 207. The connection control unit 205 determines a suitable access point through which the STA 131 accesses the desired service on a network on the basis of the result of this collation.

The connection control unit 205 executes processing of transmitting learning data possessed by the STA 131 to another client terminal. Alternatively, the connection control unit 205 executes processing of acquiring learning data from another client terminal. When learning data possessed by the STA 131 are transmitted to another client terminal, the connection control unit 205 encrypts the learning data for each record regarding an access point using a security key recorded on the storage medium 207 for each access point. When encrypted learning data have been acquired from another client terminal, the connection control unit 205 decodes the encrypted learning data for each record regarding an access point using a security key of the access point recorded on the storage medium 207.

The connection control unit 205 may read a program including commands defining the operations of the connection control unit 205 and execute the read program. In other words, the functions of the connection control unit 205 may be realized by software. This program, for example, may be provided by using a “computer-readable storage medium” such as a flash memory. In addition, the program described above may be transmitted from a computer including a storage device and the like in which this program is stored to the STA 131 through a transmission medium or by using carrier waves in a transmission medium. The “transmission medium” transmitting a program is a medium that has a function of transmitting information such as a network (communication network) including the Internet and the like or a communication circuit line (communication line) including a telephone circuit line and the like. In addition, the program described above may realize at least some of the functions described above. Furthermore, the program described above may be a differential file (differential program) that can realize the functions described above in combination with a program that has already been recorded in a computer.

The connection control unit 205 transmits information to another apparatus by using the communicator 204. Specifically, the connection control unit 205 controls the communicator 204 such that information is transmitted to another apparatus. In other words, the connection control unit 205 causes the communicator 204 to transmit information for another apparatus. In this way, the communicator 204 transmits information to another apparatus. The connection control unit 205 receives information from another apparatus by using the communicator 204. Specifically, the connection control unit 205 controls the communicator 204 such that information is received from another apparatus. In other words, the connection control unit 205 causes the communicator 204 to receive information transmitted from another apparatus. In this way, the communicator 204 receives information from another apparatus.

The application 206 is a browser application, a setting browsing application, a data sharing application, or the like. The browser application can receive a web service provided by a terminal of the cloud 111. The setting browsing application can receive a service of monitoring settings and states provided by the apparatus 112. The data sharing application can receive a data sharing service provided by the device 113. The application 206 is not limited to these applications. STA 131 may have a plurality of different applications.

The storage medium 207 is a nonvolatile storage device. For example, the storage medium 207 is at least one of an erasable programmable read only memory (EPROM), an electrically erasable programmable read-only memory (EEPROM), a flash memory, and a hard disk drive. The storage medium 207 stores learning data including information acquired from a communication request from the application 206. In addition, the storage medium 207 stores an SSID, a security key, and the like necessary for connection to an access point. The STA 131 may include a plurality of storage mediums and learning data, an SSID, and a security key may be stored on different storage mediums.

The STA 131 may not include at least one of the display 202 and the input interface 203.

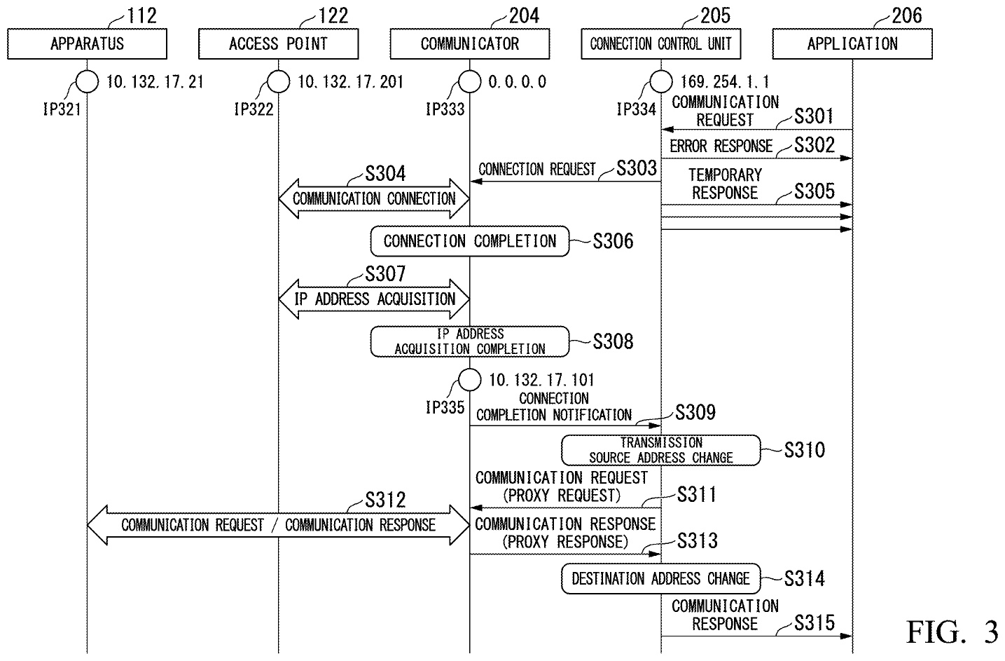

FIG. 3 shows a sequence when the application 206 performs communication. In FIG. 3, a sequence when the STA 131 starts use of a service provided by the apparatus 112 of the network 102 is shown. The network address of the network 102 is 10.132.17.0/24. The IP address of the apparatus 112 that belongs to the network 102 is set to 10.132.17.21 (IP321) in advance. The IP address of the access point 122 is set to 10.132.17.201 (IP322) in advance. The STA 131 is in a state in which the STA 131 is not connected to any access point and the communicator 204 is in a state in which an IP address is not set (IP333). On the other hand, the connection control unit 205 holds the IP address 169.254.1.1 (IP334) as a local IP address. When the application 206 ranked higher than the connection control unit 205 performs communication, the connection control unit 205 uses this IP address.

The application 206 generates a communication request that is a service request (Step S301). If the application 206 is a web browser, the communication request is a hypertext transfer protocol (HTTP) request. The connection control unit 205 temporarily holds the communication request transferred from the application 206 to the communicator 204. The connection control unit 205 notifies the communicator 204 of a connection request in accordance with the contents of the communication request (Step S303) or returns an error response to the application 206 (Step S302). When the connection control unit 205 returns the error response to the application 206, subsequent processing is not executed. Determination regarding the connection request and the error response will be described later.

At the time when the connection control unit 205 notifies the communicator 204 of a connection request without returning an error response to the application 206, an IP address has not been set to the communicator 204 yet. The communicator 204 executes wireless connection processing with the access point 122 in accordance with the connection request from the connection control unit 205 (Step S304). In this way, the communicator 204 establishes communication connection with the access point 122.

While the communicator 204 executes connection processing with the access point 122, the connection control unit 205 generates a temporary response message and outputs the temporary response message to the application 206. In other words, the connection control unit 205 notifies the application 206 of the temporary response message (Step S305). In light of the fact that the connection processing requires a lot of time, the temporary response message is notified, for example, for the purpose of informing a user of the current state.

When a communication request from a web browser has been generated, the connection control unit 205 generates hypertext markup language (HTML) contents as a temporary response message and notifies the application 206 of the contents. HTML contents are written such that a user can visually understand words meaning “under connection” or the like and polling settings or the like are described by using a script language or the like. As described above, a response message is generated in consideration of preventing the application 206 from completing a communication transaction when the application 206 receives the temporary response message.

Wireless connection between the communicator 204 and the access point 122 is completed (Step S306). Thereafter, the communicator 204 acquires an IP address (Step S307). Acquisition of an IP address is generally performed through a sequence of a dynamic host configuration protocol (DHCP) request/response. The access point 122 of the network 102 has a DHCP server function. This may be used. Alternatively, a DHCP server different from the access point 122 may be established within the network 102.

Through the sequence of the DHCP request/response, the communicator 204 completes acquisition of an IP address from a DHCP server (Step S308). The communicator 204 acquires the IP address 10.132.17.101 (IP335). Connection to a network is completed by acquiring the IP address. In other words, the communicator 204 has connected to the access point 122. The communicator 204 notifies the connection control unit 205 of connection completion (Step S309).

The connection control unit 205 changes a transmission source address (IP334) included within the IP header of the held communication request (Step S301) to the IP address (IP335) acquired in Step S307 (Step S310). The connection control unit 205 notifies the communicator 204 of the communication request of which the transmission source address has been changed (Step S311). The communicator 204 transmits the communication request to the apparatus 112 of the network 102 (Step S312).

The communication request reaches the apparatus 112 via the access point 122. The communicator 204 receives a communication response returned from the apparatus 112. The communicator 204 notifies the connection control unit 205 of the received communication response (Step S313). The connection control unit 205 changes a destination address (IP335) included in the IP header of the received communication response to the IP address (IP334) held by the connection control unit 205 (Step S314). The connection control unit 205 returns the communication response to the application 206 as a response to the communication request (Step S301) from the application 206 (Step S315).

The operation in the state in which the communicator 204 has not connected to a network is described above. The operation when the communicator 204 has already connected to any one of the access points and participated in any one of the networks will be described. There are cases where it is determined that the communicator 204 needs to connect to another access point different from the access point to which the communicator 204 is currently connecting as a consequence of analyzing the communication request (Step S301) from the application 206.

In such cases, the connection request notified to the communicator 204 by the connection control unit 205 also represents disconnection of communication with the access point to which the communicator 204 is currently connecting. Therefore, the communicator 204 connects to a desired access point after disconnecting communication connection with the access point to which the communicator 204 is currently connecting. The IP address given when the communicator 204 previously connected to an access point is handled similarly to the IP address given when the communicator 204 does not connect to an access point. The IP address used before the IP address (IP335) is newly acquired is overwritten by the newly acquired IP address.

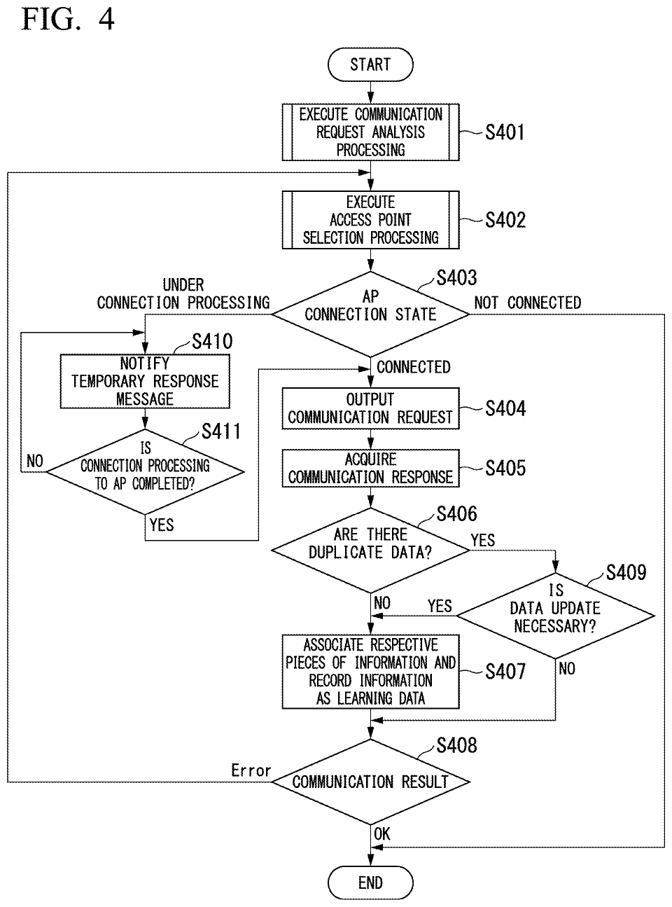

FIG. 4 shows processing in accordance with a communication request from the application 206 and processing of recording variety of pieces of acquired information as learning data. When the connection control unit 205 is notified of a communication request, the connection control unit 205 analyzes the notified communication request (Step S401). It is assumed that IP packet communication is performed in the embodiment of the present invention. A communication request is notified by using an IP packet frame.

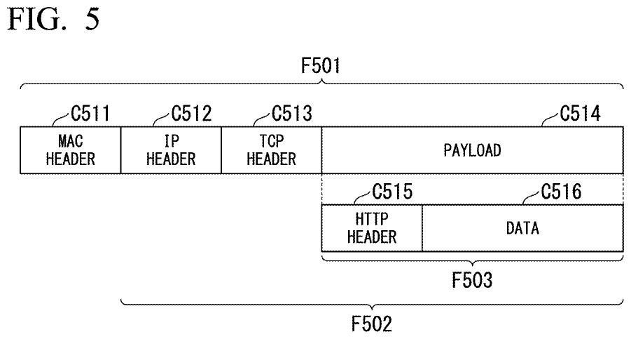

FIG. 5 shows a configuration of a packet frame. A communication request transmitted to the apparatus 112 and a communication response received from the apparatus 112 through the access point 122 by the communicator 204 are constituted by a frame F501. The frame F501 includes a media access control (MAC) header C511, an internet protocol (IP) header C512, a transmission control protocol (TCP) header C513, and a payload C514. The frame F501 includes use information for using a service. The use information includes a destination address (sixth information), a protocol type (seventh information), a destination port number (seventh information), and User-Agent (fifth information).

The MAC header C511 means a header of the IEEE802.11 frame. The MAC header C511 is given by the communicator 204 when the communicator 204 communicates with an access point. A communication request notified from the application 206 to the communicator 204 through the connection control unit 205 and a communication response notified to the application 206 through a reverse path are constituted by a frame F502. The frame F502 includes the IP header C512, the TCP header C513, and the payload C514. If the communication request from the application 206 is an HTTP request from a web browser, the payload C514 is constituted by the frame F503. The frame F503 includes an HTTP header C515 and data C516.

Therefore, when the connection control unit 205 analyzes the communication request from the application 206, the connection control unit 205 acquires a destination address and a protocol type included in the IP header C512 of the frame F502 and acquires a destination port number included in the TCP header C513 of the frame F502. The destination address represents an IP address of a service providing terminal. The protocol type and the destination port number identifies a protocol for using a service.

If the communication request is the HTTP request, the connection control unit 205 acquires User-Agent from the HTTP header CS15 included in the payload C514. An application name is included in the User-Agent. In other words, the User-Agent identifies an application. For this reason, the connection control unit 205 uses the User-Agent as an application type. Hereinafter, the application type is described as an activation application type.

A protocol type can be estimated from a destination port number. For example, even when a protocol type acquired from the IP header C512 is TCP, if a destination port number included in a TCP header is 80, HTTP ranked higher in the OSI reference model can be estimated as the protocol type. When a protocol type can be estimated from a destination port number, the connection control unit 205 uses HTTP instead of TCP as a protocol type.

When the communication request in Step S301 is notified from the application 206, the connection control unit 205 acquires User-Agent, a destination address, a protocol type, and a destination port number in Step S401 on the basis of user information included in the communication request.

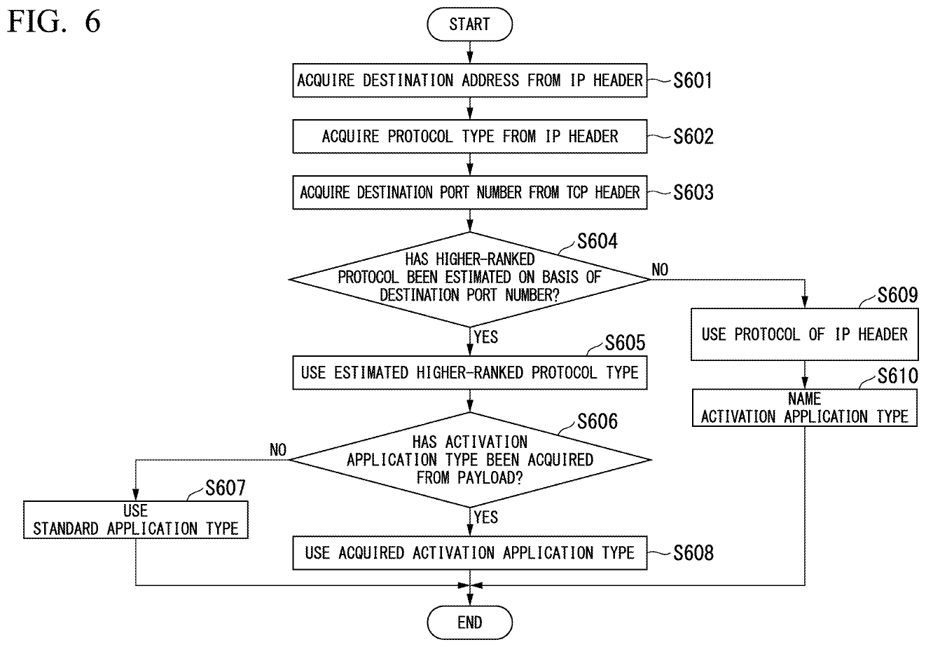

Details of the processing in Step S401 will be described. FIG. 6 shows the processing in Step S401.

The connection control unit 205 acquires a destination address from the IP header C512 of an IP packet frame constituting the communication request (Step S601). After Step S601, the connection control unit 205 acquires a protocol number from the IP header C512 (Step S602).

A protocol number is defined in the standard. For example, the protocol corresponding to a protocol number 6 is TCP and the protocol corresponding to a protocol number 17 is the user datagram protocol (UDP). In the embodiment of the present invention, names called as TCP and UDP are used as protocol types.

After Step S602, the connection control unit 205 acquires a destination port number from the TCP header C513 (Step S603). The order of processing in Step S601 to Step S603 is not limited to the order shown in FIG. 6.

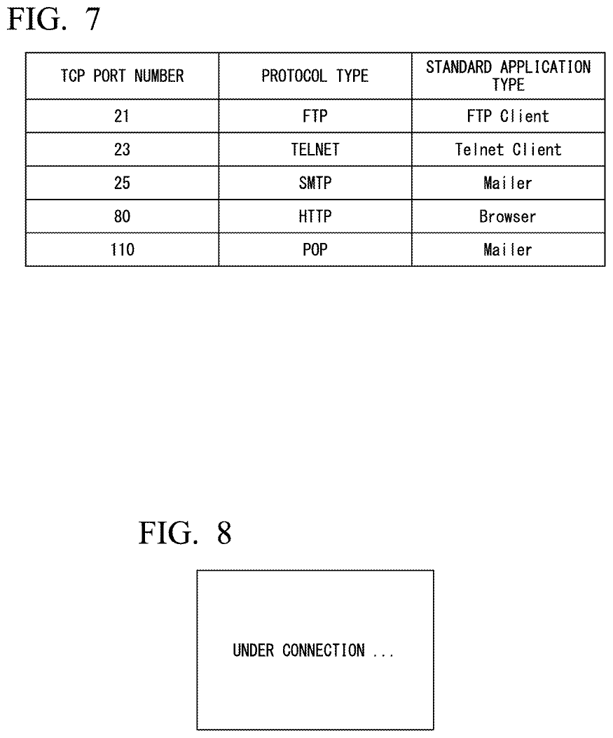

A defined number called as a well-known port or non-defined number is included in a destination port number. FIG. 7 shows a table in which the relationship between a destination port number, a protocol type, and an application type are defined. As shown in FIG. 7, a TCP port number (destination port number), a protocol type, and a standard application type (activation application type) are associated with each other. The TCP port number shown in FIG. 7 is a defined port number called as the well-known port. The storage medium 207 stores the table shown in FIG. 7.

After Step S603, the connection control unit 205 estimates an upper-ranked protocol on the basis of the destination port number (Step S604). The connection control unit 205 can estimate a protocol corresponding to a defined destination port number on the basis of the table shown in FIG. 7. When the connection control unit 205 has estimated the upper-ranked protocol, the connection control unit 205 uses the estimated upper-ranked protocol as the protocol type (Step S605). For example, if the destination port number is defined 80, the protocol is HTTP. In this case, the connection control unit 205 uses HPPT as the protocol type.

After Step S605, the connection control unit 205 acquires an activation application type from the payload C514 of a packet frame (Step S606). For example, if the destination port number is 80, the connection control unit 205 acquires User-Agent from the HTTP header C515 included in the payload C514 of the packet frame. The connection control unit 205 uses the acquired activation application type (Step S608).

There are cases where the connection control unit 205 is unable to acquire the activation application type, as with the case where User-Agent is not included in the payload C514 or other cases. In such cases, the connection control unit 205 acquires the standard application type corresponding to the TCP port number from the table shown in FIG. 7. The connection control unit 205 uses the acquired standard application type as the activation application type (Step S607). For example, when the destination port number is 80 and the connection control unit 205 is unable to acquire User-Agent from the HTTP header C515, the connection control unit 205 uses Browser as the activation application type.

When the destination port number in the TCP header C513 is a non-defined number such as 4000, the connection control unit 205 is unable to estimate the upper-ranked protocol on the basis of the table shown in FIG. 7 in Step S604. In such a case, the connection control unit 205 acquires the protocol type from the IP header C512 and uses the acquired protocol type (Step S609).

After Step S609, the connection control unit 205 names the activation application type and uses the activation application type (Step S610). For example, the destination port number in the TCP header C513 and a proper character string are combined. For example, a name such as “40001APP” that can be distinguished from others is given.

When the processing of any one of Step S607, Step S608, and Step S610 is executed, the processing shown in FIG. 6 is finished and the processing in Step S402 is executed. The processing in Step S609 and Step S610 is independent of the processing in Steps S605 to S608. For this reason, the processing in Step S609 and Step S610 is not essential. The processing in Step S607 and the processing in Step S608 are independent of each other. For this reason, any one of the processing in Step S607 and the processing in Step S608 may not be executed.

The remainder of the processing shown in FIG. 4 will be described. After Step S401, the connection control unit 205 executes processing of selecting an access point that is able to access a network to which the desired service belongs (Step S402). Details of the processing in Step S402 will be described later.

After Step S402, the connection control unit 205 monitors a state of connection to an access point (Step S403). When connection to an access point is not performed, the connection control unit 205 finishes the processing. At this time, communication connection between an access point and the communicator 204 has not been established.

While the communicator 204 executes connection processing to an access point, the connection control unit 205 generates a temporary response message and outputs the temporary response message to the application 206 in consideration of the case where it takes long to connect to the access point. In other words, the connection control unit 205 notifies the application 206 of the temporary response message (Step S410). This processing corresponds to Step S305. At this time, although communication connection between an access point and the communicator 204 has not been established, the connection processing in Step S304 is under execution. If the communication request is an HTTP request from a web browser, HTML contents in the form of an HTTP response are notified to the application 206 as the temporary response message.

FIG. 8 shows contents of the temporary response message notified to the application 206 in Step S410. As shown in FIG. 8, descriptions to visually convey the current state to a user are included. The contents shown in FIG. 8 represent the state under execution of the connection processing, that is, the state under connection. In addition, polling processing and the like are performed in the HTML contents by using a script language or the like to prevent the HTTP communication transaction from being completed due to this response message. In this way, HTTP request from the application 206 is regularly performed. As described above, the communication response notified to the application 206 is constituted by the frame F502. The data C516 included in the payload C514 of the frame F502 include response data that represent contents of the response message.

While the temporary response message is output to the application 206, the connection control unit 205 repeatedly monitors progress of the connection processing to an access point (Step S411). When the connection processing is not completed, the connection control unit 205 repeats outputting the temporary response message to the application 206. After the connection control unit 205 confirms completion of the connection processing, the connection control unit 205 outputs a communication request to the communicator 204 (Step S404). This processing corresponds to Step S311. A transmission source address in the communication request output to the communicator 204 has been changed from a transmission source address in the communication request output from the application 206.

After the communication request is output, the connection control unit 205 acquires a communication response for the communication request from the communicator 204 (Step S405). This processing corresponds to Step S313.

Contents of the communication response include a normal response and an error response. In the learning data, a communication result (communication result information), information included in the communication request, and information (SSID) that identifies the access point connected to by the communicator 204 are associated with each other. The communication result is either “OK” or “Error”. The information included in the communication request is the activation application type, the destination address, the port number, and the protocol type. After Step S405, the connection control unit 205 confirms the learning data recorded on the storage medium 207. The connection control unit 205 determines whether or not there are data including information that overlaps information on communication with a service providing terminal in the learning data (Step S406).

Confirmation of overlapping data is performed on information excluding the communication result. In other words, the connection control unit 205 collates an SSID of an access point connected to by the communicator 204 in communication with a service providing terminal with an SSID of an access point included in the learning data. The connection control unit 205 collates the activation application type in the communication with the service providing terminal with the activation application type included in the learning data. The connection control unit 205 collates the destination address in the communication with the service providing terminal with the destination address included in the learning data. The connection control unit 205 collates the protocol type in the communication with the service providing terminal with the protocol type included in the learning data. When all the pieces of information included in the same record of the learning data match respective pieces of information in the communication with the service providing terminal, the overlapping data are present. When at least one piece of information included in the same record of the learning data does not match corresponding piece of information in the communication with the service providing terminal, the overlapping data are not present.

When the overlapping data are present, the connection control unit 205 determines whether or not data update is necessary (Step S409). If data update is necessary, the connection control unit 205 updates the learning data recorded on the storage medium 207 (Step S407). For example, when the communication result has changed, as with the case where the communication result is “OK” in the past data and the communication result this time is “Error”, the connection control unit 205 updates the learning data.

In the confirmation of overlapping data (Step S406), when the overlapping data are not present, the connection control unit 205 associates pieces of information in the communication with the service providing terminal with each other and records the information on the storage medium 207 as the learning data. In other words, the connection control unit 205 associates an access point type, each of pieces of information acquired from the communication request, and the communication result with each other and records these pieces of information on the storage medium 207 (Step S407). When the communication result is “Error”, the connection control unit 205 may not record data. Only when the communication result is “OK”, the connection control unit 205 may record the data.

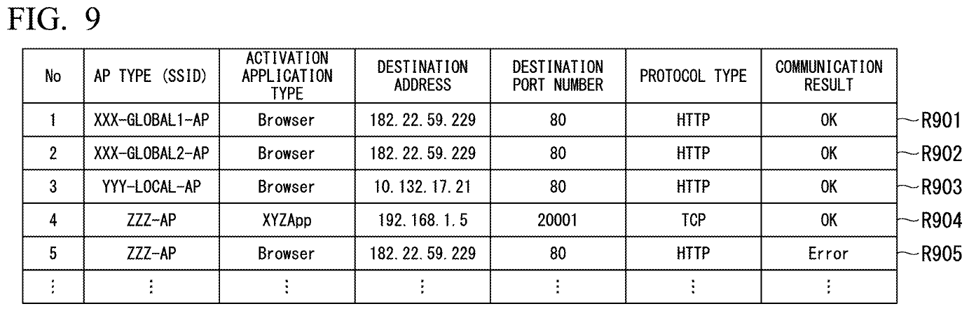

FIG. 9 shows contents of the learning data (service information). The learning data include a plurality of records. In FIG. 9, a record R901, a record R902, a record R903, a record R904, and a record R905 are shown. Each record of the learning data includes an access point type (AP type, i.e., SSID) (first information), an activation application type (second information), a destination address (third information), a destination port number (fourth information), a protocol type (fourth information), and a communication result.

The record R901 and the record R902 include information acquired from the communication request when the communicator 204 communicates with a service providing terminal of the network 101. Since the communicator 204 has connected to two access points consisting of the access point 121 and the access point 124 having different access point types that are present on the network 101, two records are recorded. In the network environment including a plurality of access points per one network, a record is recorded every access point like this. An IP address recorded in the record R905 is an IP address of a service providing terminal on the network 101. The record R905 shows that the communicator 204 tried to communicate with a service providing terminal on the network 101. However, since the desired service is not present on the network 101, the fact that the communication result has been “Error” is recorded in the record R905. The learning data may not include the communication result.

After the learning data are recorded, the connection control unit 205 executes processing in accordance with the communication result. Alternatively, when data update is unnecessary in Step S409, the connection control unit 205 executes processing in accordance with the communication result (Step S408). If the communication result is “Error”, an access point is selected in Step S402. If the communication result is “OK”, the connection control unit 205 outputs the communication result to the application 206 as a communication response. In this case, the connection control unit 205 completes the processing.

The connection control unit 205 may acquire the learning data from another client terminal. Therefore, the connection control unit 205 may not execute the processing in Step S407. The processing in Step S410 and Step S411 is not essential.

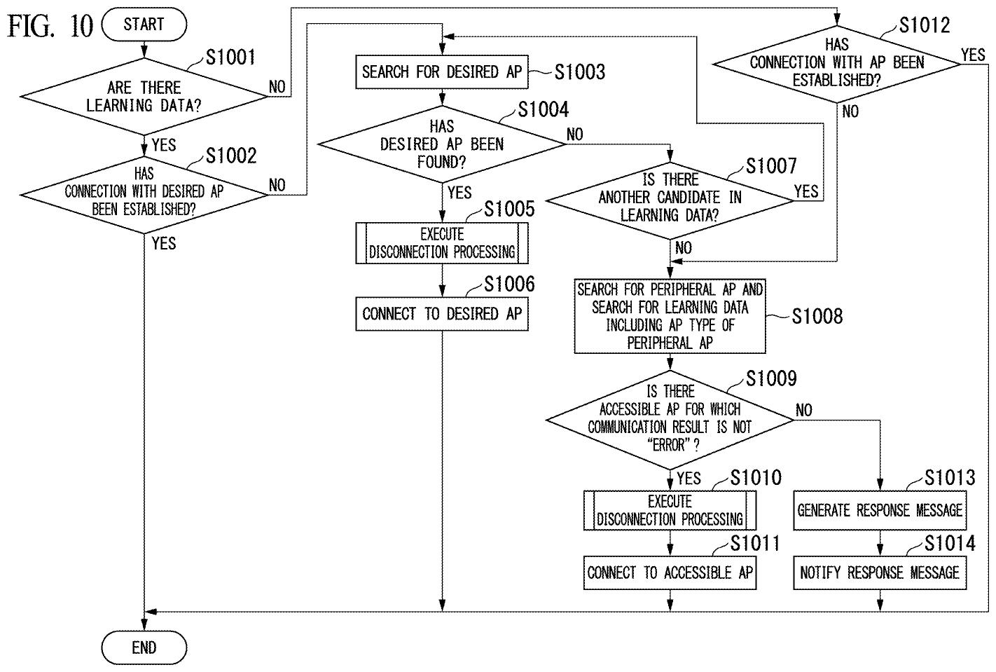

Details of the processing in Step S402 will be described. FIG. 10 shows a first example of the processing in Step S402.

The connection control unit 205 collates the information acquired from the communication request in Step S401 with information included in the learning data. In this way, the connection control unit 205 determines whether or not there is the learning data that match the information acquired from the communication request (Step S1001).

This determination is performed on the basis of information excluding the access point type (SSID). In other words, the connection control unit 205 collates the activation application type (fifth information) acquired from the communication request with the activation application type (second information) included in the learning data. The connection control unit 205 collates the destination address (sixth information) acquired from the communication request with the destination address (third information) included in the learning data. The connection control unit 205 collates the protocol type (seventh information) acquired from the communication request with the protocol type (fourth information) included in the learning data. The connection control unit 205 collates the destination port number (seventh information) acquired from the communication request with the destination port number (fourth information) included in the learning data. The processing in Step S1001 corresponds to the determination processing.

When all pieces of information included in the same record of the learning data match respective pieces of information acquired from the communication request, the learning data that match the information acquired from the communication request are present. When at least one piece of information included in the same record of the learning data does not match corresponding piece of information acquired from the communication request, the learning data that match the information acquired from the communication request are not present.

When the learning data that match the information acquired from the communication request are present, the connection control unit 205 acquires the access point type associated with the learning data from the learning data. The connection control unit 205 determines whether or not the communicator 204 has connected to the access point corresponding to the access point type (Step S1002).

When the communicator 204 has established communication connection with the access point and the communication connection is sustained, the communicator 204 has connected to the access point. When communication connection between the access point and the communicator 204 is not sustained, the communicator 204 has not connected to the access point. For example, when the communicator 204 has not connected to any access point, the communicator 204 has not connected to the desired access point that is the target for the determination. Alternatively, when the communicator 204 has connected to an access point different from the desired access point, the communicator 204 has not connected to the desired access point. When the communicator 204 has connected to the desired access point, the processing shown in FIG. 10 is completed and the processing in Step S403 is executed.

When the communicator 204 has not connected to the desired access point, the connection control unit 205 searches for the desired access point by scanning an access point that is present around the STA 131 by using the communicator 204 (Step S1003). The connection control unit 205 determines whether or not the desired access point has been found on the basis of the search result (Step S1004).

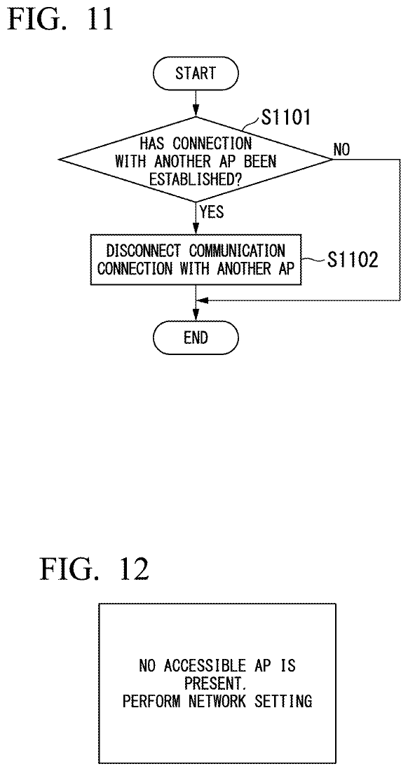

When the connection control unit 205 has found the desired access point, the connection control unit 205 executes processing regarding disconnection of the communication connection between an access point and the communicator 204 (Step S1005). FIG. 11 shows the processing in Step S1005.

The connection control unit 205 determines whether or not the communicator 204 has connected to another access point different from the desired access point (Step S1101). When the communicator 204 has established communication connection with another access point and the communication connection is sustained, the communicator 204 has connected to another access point. When communication connection between another access point and the communicator 204 is not sustained, the communicator 204 has not connected to another access point.

When the communicator 204 has not connected to another access point, the processing shown in FIG. 11 is completed and the processing in Step S1006 is executed. When the communicator 204 has connected to another access point, the connection control unit 205 causes the communicator 204 to disconnect a communication connection with another access point. In this way, the communicator 204 disconnects the communication connection with another access point (Step S1102). After Step S1102, the processing in Step S1006 is executed.

The remainder of the processing shown in FIG. 10 will be described. The connection control unit 205 executes connection processing to the desired access point by using the communicator 204. In other words, the connection control unit 205 connects to the access point by using the communicator 204 (Step S1006). In other words, when each of pieces of information acquired from the communication request matches corresponding piece of information included in the learning data, the connection control unit 205 connects to the access point represented by the access point type associated with the information matching the information acquired from the communication request by using the communicator 204. This processing corresponds to Steps S303 to S310. In this way, the processing shown in FIG. 10 is completed and the processing in Step S403 is executed.

When the connection control unit 205 has not found the desired access point, the connection control unit 205 determines whether or not there is another candidate for an access point is present in the learning data (Step S1007). The method of determination in Step S1007 is similar to that in Step S1001. When another candidate for an access point is present, the processing in Step S1003 is executed.

For example, there are cases where the STA 131 uses a service provided on a network including a plurality of access points such as the network 101 shown in FIG. 1. A plurality of records matching the information included in the communication request may be present in the learning data such as the record R901 and the record R902 shown in FIG. 9.

For example, when confirmation of the learning data (Step S1001) is performed for the first time, the record R901 is extracted. When the desired access point 121 has not been found, the connection control unit 205 performs confirmation of the learning data (Step S1007) again. As a result of the confirmation, the record R902 is extracted. Since the access point type recorded in the record R902 corresponds to the access point 124, the connection control unit 205 searches for the access point 124 in Step S1003. When the access point 124 has been found, the connection control unit 205 starts connection processing to the access point 124 in Step S1006.

When another candidate for no access point is present in Step S1007, the connection control unit 205 searches for an access point by scanning an access point that is present around the STA 131 by using the communicator 204. At this time, the connection control unit 205 acquires an access point type of the access point found through the search. Further, the connection control unit 205 searches the learning data for data that include the access point type of the access point found through the above-described search and include information matching the activation application type, the destination port number, and the protocol type acquired from the communication request (Step S1008). At this time, the destination address in the learning data is not used for the search.

After Step S1008, the connection control unit 205 determines whether or not there is an accessible access point for which the communication result is not “Error” on the basis of the result of Step S1008 (Step S1009). When there is data that include the access point type of the access point found through the search in Step S1008 and include the information matching the corresponding information acquired from the communication request and the communication result of the data is not “Error”, the desired access point is present. In a case other than this, the desired access point is not present.

When there is an accessible access point for which the communication result is not “Error”, the connection control unit 205 executes processing regarding disconnection of the communication connection between an access point and the communicator 204 (Step S1010). The processing in Step S1010 is similar to the processing in Step S1005.

The connection control unit 205 executes connection processing to the accessible access point 124 by using the communicator 204. In other words, the connection control unit 205 connects to the access point by using the communicator 204 (Step S1011). In other words, when the connection control unit 205 is unable to connect to the access point represented by the access point type associated with the information matching the corresponding information acquired from the communication request, the connection control unit 205 connects to the access point around the STA 131 by using the communicator 204. This processing corresponds to Steps S303 to S310. In this way, the processing shown in FIG. 10 is completed and the processing in Step S403 is executed.

In the record R905 shown in FIG. 9, the result showing that the communicator 204 connected to the access point 123 included in the network 103, tried to communicate with a service providing terminal included in the network 101, and failed in the communication is recorded. Therefore, the record R905 matches the information acquired from the communication request excluding the access point type. However, even if the access point 123 is detected, it is known that communication results in an error. For this reason, the access point 123 is excluded from an access point of a connection target.

On the other hand, in the record R903, the result showing that the communicator 204 connected to the access point 122 included in the network 102, tried to communicate with the apparatus 112 included in the network 102, and succeeded in the communication is recorded. For this reason, the connection control unit 205 starts connection processing to the access point 122 in Step S1011.

In a case where the STA 131 connects to the access point 122 included in the network 102 to use a service included in the network 101, the communication result consequently becomes “Error”. This communication result is recorded in the learning data in Step S407. Since this information is accumulated as the learning data, a waste in selection of an access point can be reduced next time and afterward.

On the other hand, when the connection control unit 205 has not detected an access point accessible by the communicator 204 on the ground that no access point is present around the STA 131 or the like, the connection control unit 205 generates a response message (Step S1013). The connection control unit 205 outputs the generated response message to the application 206. In other words, the connection control unit 205 notifies the application 206 of the response message (Step S1014). The processing in Step S1013 and Step S1014 corresponds to Step S302. In this way, the processing shown in FIG. 10 is completed and the processing in Step S403 is executed.

FIG. 12 shows the contents of the response message notified to the application 206 in Step S1014. In a case where the communication request is the HTTP request, the response message is formed of the HTTP response and the HTML contents are used. As shown in FIG. 12, descriptions to visually convey the fact that no accessible access point is present and resetting of a network is necessary to a user are included. Polling setting or the like in the HTML contents by using a script language or the like is not performed for this response message and a communication transaction of the connection control unit 205 and the application 206 is completed.

In Step S1001, when no learning data that match the information acquired from the communication request is present, the connection control unit 205 determines whether or not the communicator 204 has connected to an access point (Step S1012).

When the communicator 204 has established communication connection with any access point and the communication connection is sustained, the communicator 204 has connected to the access point. When communication connection between any access point and the communicator 204 is not sustained, the communicator 204 has not connected to the access point. When the communicator 204 has connected to an access point, the processing in FIG. 10 is completed and the processing in Step S403 is executed. When the communicator 204 has not connected to an access point, the processing in Step S1008 is executed.

The processing in Steps S1007 to S1014 is independent of the processing in Step S1005 and Step S1006. For this reason, the processing in Steps S1007 to S1014 is not essential.

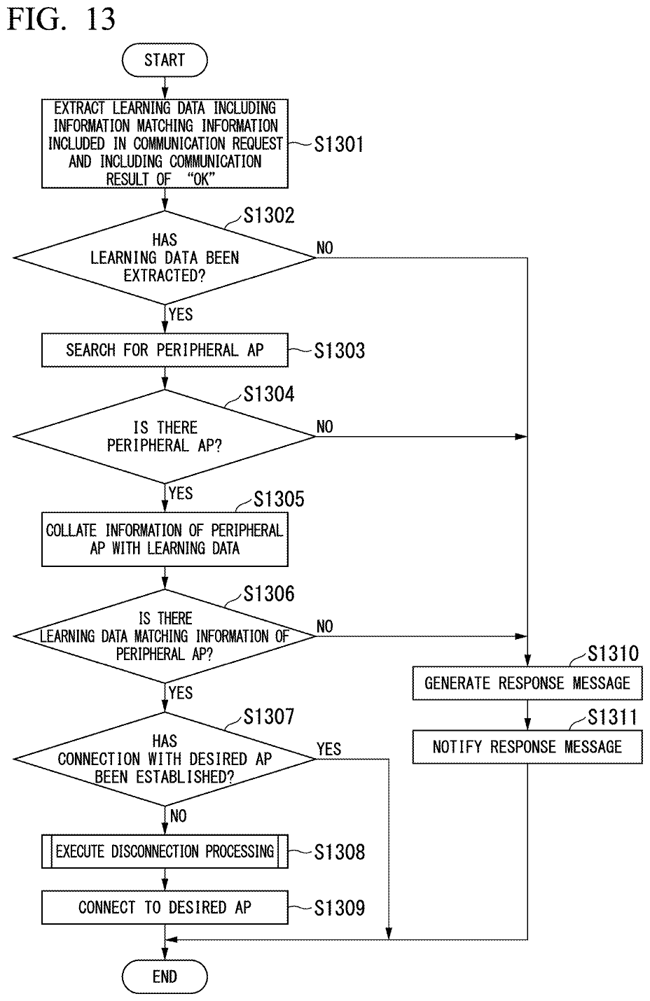

FIG. 13 shows a second example of the processing in Step S402. In the second example, a record in which “Error” has been recorded in the accumulated learning data is excluded from a target for use. In addition, in the second example, only when pieces of information acquired from the communication request match respective pieces of information of the learning data, connection processing to an access point corresponding to the information is started. In the second example, the STA 131 holds the learning data in advance and connects to an access point determined on the basis of the learning data.

The connection control unit 205 extracts data including information that matches the information acquired from the communication request in Step S401 and including the communication result of “OK” out of the learning data (Step S1301). In this way, a record in which “Error” has been recorded is excluded.

After Step S1301, the connection control unit 205 determines whether or not data satisfying the condition have been extracted (Step S1302). When the data satisfying the condition have been extracted, the connection control unit 205 searches for an access point by scanning an access point that is present around the STA 131 by using the communicator 204. At this time, the connection control unit 205 acquires an access point type of the access point found through the search (Step S1303).

After Step S1303, the connection control unit 205 determines whether or not an access point is present around the STA 131 on the basis of the search result (Step S1304). When an access point is present around the STA 131, the connection control unit 205 collates an access point type of the access point around the STA 131 with the access point type of the learning data extracted in Step S1301 (Step S1305).

After Step S1305, the connection control unit 205 determines whether or not data including the access point type that matches the access point type of the access point around the STA 131 are present on the basis of the collation result (Step S1306). When the data including the access point type that matches the access point type of the access point around the STA 131 are present, the connection control unit 205 determines whether or not the communicator 204 has connected to the access point corresponding to the access point type (Step S1307). The method of determination in Step S1307 is similar to that in Step S1002.

When the communicator 204 has connected to the access point, the processing shown in FIG. 13 is completed and the processing in Step S403 is executed. When the communicator 204 has not connected to the access point, the connection control unit 205 executes processing regarding disconnection of the communication connection between an access point and the communicator 204 (Step S1308). The processing in Step S1308 is similar to the processing in Step S1005.

After Step S1308, the connection control unit 205 executes connection processing to the desired access point by using the communicator 204. In other words, the connection control unit 205 connects to the access point by using the communicator 204 (Step S1309). In other words, when each of pieces of information acquired from the communication request matches corresponding piece of information included in the learning data, the connection control unit 205 connects to the access point represented by the access point type associated with the information matching the information acquired from the communication request by using the communicator 204. This processing corresponds to Steps S303 to S310. In this way, the processing shown in FIG. 13 is completed and the processing in Step S403 is executed.

As a result of the processing in Step S1301, when the data satisfying the condition have not been extracted, no accessible access point is present. In this case, the connection control unit 205 generates a response message (Step S1310). The connection control unit 205 outputs the generated response message to the application 206. In other words, the connection control unit 205 notifies the application 206 of the response message (Step S1311). The processing in Step S1310 and Step S1311 corresponds to Step S302. In this way, the processing shown in FIG. 13 is completed and the processing in Step S403 is executed.

Also, when no access point is present around the STA 131 in Step S1304, the processing in Step S1310 and Step S1311 is executed. Also, when the data including the access point type that matches the access point type of the access point around the STA 131 are not present, the processing in Step S1310 and Step S1311 is executed.

The processing in Step S1310 and Step S1311 is not essential.

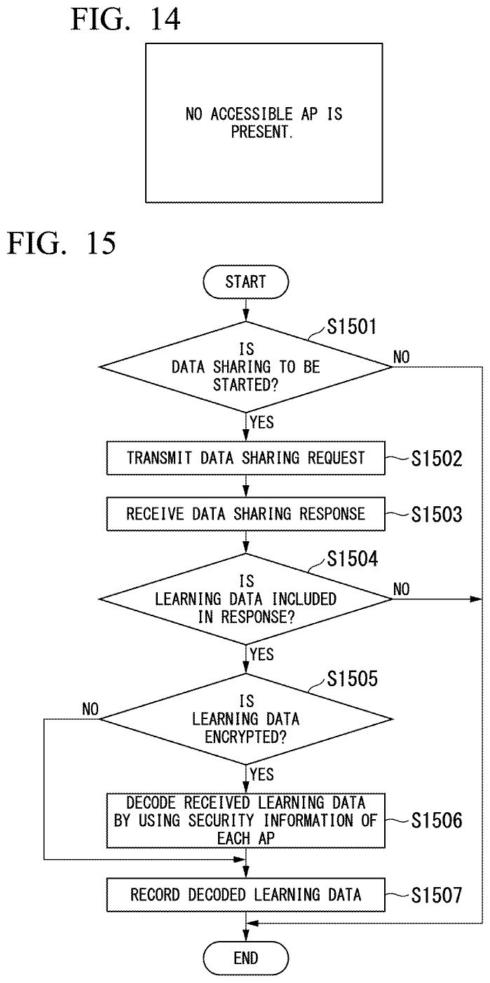

FIG. 14 shows the contents of the response message notified to the application 206 in Step S1311. In a case where the communication request is the HTTP request, the response message is formed of the HTTP response and the HTML contents are used. As shown in FIG. 14, descriptions to visually convey the fact that no accessible access point is present to a user are included.

FIG. 15 shows processing for the STA 131 and the STA 132 to share the learning data. Hereinafter, a case where the learning data are transmitted from the STA 131 to the STA 132 will be described. In the descriptions below, a terminal that receives the learning data is called as a client and a terminal that gives the learning data to the client is called as a server.

It is assumed that sharing of the learning data is performed in a state where a plurality of terminals such as the STA 131 and the STA 132 have participated in the same network. For example, when the STA 132 has already participated in the network 102 and the STA 131 newly connects to the network 102, sharing of the learning data is performed. FIG. 0.15 shows the processing in the STA 131 that is a terminal receiving the learning data, that is, the client.

The connection control unit 205 determines whether or not data sharing is to be started (Step S1501). For example, when a user performs network setting and the STA 131 connects to a network for the first time, the data sharing is performed. Alternatively, when an event in which, for example, a user inputs an operation of starting sharing through the input interface 203, the data sharing is performed.

In a case where the data sharing is not started, the processing shown in FIG. 15 is completed. In a case where the data sharing is started, the connection control unit 205 generates a data sharing request. The connection control unit 205 transmits the data sharing request through broadcast by using the communicator 204 in the network to which the communicator 204 is connecting (Step S1502). The data sharing request is a packet of TCP. A broadcast address is included in the destination address of the data sharing request. The IP address of the STA 131 is included in the transmission source address of the data sharing request. An identifier that means the data sharing request is included in the data sharing request.

The data sharing request reaches all the terminals that connect to the network in which the STA 131 participates. A terminal that has received this message returns a data sharing response. In this example, the STA 132 receives this message and returns the data sharing response. Therefore, the STA 131 receives the data sharing response from the STA 132. The connection control unit 205 receives the data sharing response by using the communicator 204. In this way, the connection control unit 205 receives encrypted learning data from the STA 132 by using the communicator 204 (Step S1503).

After Step S1503, the connection control unit 205 determines whether or not learning data is included in the received data sharing response (Step S1504). When the learning data is not included in the data sharing response, the processing shown in FIG. 15 is completed. When the learning data is included in the data sharing response, the connection control unit 205 determines whether or not the learning data included in the data sharing response is encrypted (Step S1505).

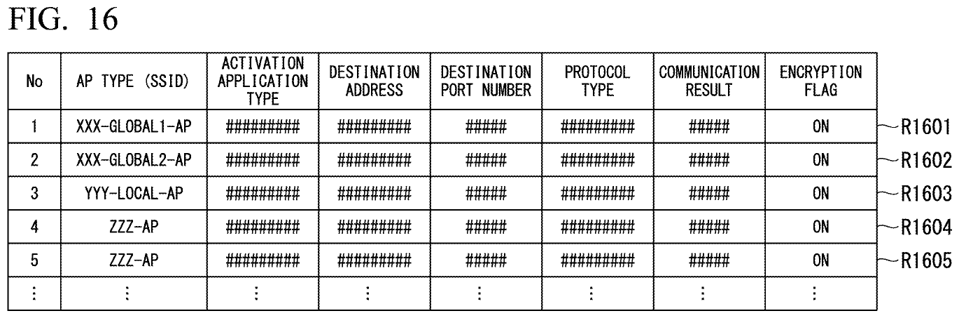

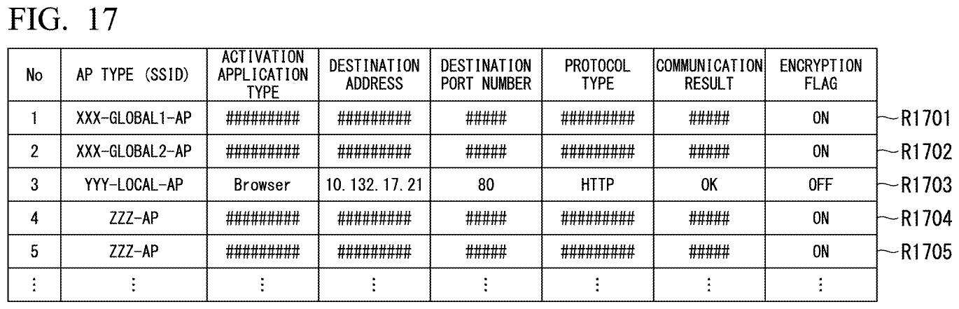

FIG. 16 and FIG. 17 show the contents of the learning data received from another terminal. The learning data includes a plurality of records. In FIG. 16, a record R1601, a record R1602, a record R1603, a record R1604, and a record R1605 are shown. In FIG. 17, a record R1701, a record R1702, a record R1703, a record R1704, and a record R1705 are shown. Each record of the learning data includes an access point type (AP type, i.e., SSID), an activation application type, a destination address, a destination port number, a protocol type, a communication result, and an encryption flag.

As shown in FIG. 16, in each record of the learning data, data other than the access point type are encrypted. The contents of the encrypted data are unable to be identified. The encryption flag represents whether or not each record is encrypted. In a case where each record is encrypted, the encryption flag is “ON.” In a case where each record is not encrypted, the encryption flag is “OFF.”

For example, in the record R1601, the access point type represents the access point 121. Security information for the communicator 204 to connect to each access point is stored on the storage medium 207 for each access point. In a server, the connection control unit 205 encrypts the data of the record R1601 on the basis of the security information corresponding to each access point. For example, when the communicator 204 connects to the access point 121, “AES” is used as an encryption algorithm and “12345678” is used as a passphrase. The passphrase is a security key (encryption key). In this case, the connection control unit 205 encrypts the data of the record R1601 by using the encryption algorithm and the passphrase.

When the learning data included in the data sharing response is not encrypted, the processing in Step S1507 is executed. When the learning data included in the data sharing response is encrypted, the connection control unit 205 decodes each record of the learning data on the basis of the security information stored on the storage medium 207. In other words, the connection control unit 205 decodes the learning data by using the encryption key used when the communicator 204 connects to the access point identified by the access point type included in the learning data (Step S1506).

In a case where the record R1603 is decoded, the record R1603 becomes the record R1703. In this example, the record R1703 is decoded by using the security information of the access point 122. If the STA 131 does not possess the security information of another access point, the connection control unit 205 is unable to decode the record other than the record R1703.

After the received learning data is decoded, the connection control unit 205 records the record that has been decoded on the storage medium 207 as the learning data (Step S1507). In this way, the processing shown in FIG. 15 is completed.

Regardless of whether or not the connection control unit 205 has decoded the received learning data, the connection control unit 205 may record all the pieces of received learning data on the storage medium 207. Thereafter, the connection control unit 205 may sequentially decode each record of the learning data when the condition under which the learning data is able to be decoded is satisfied.

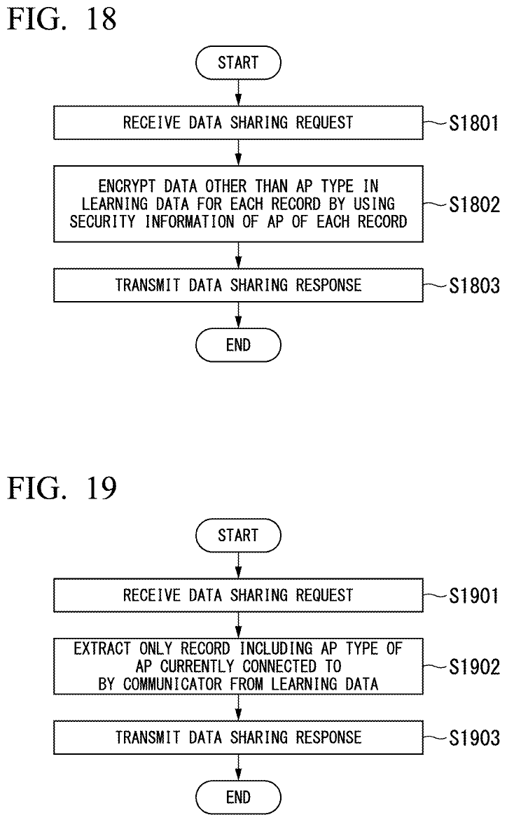

FIG. 18 and FIG. 19 show processing in the STA 132 that is a terminal, i.e., a server that gives learning data to a client.

A first example will be described with reference to FIG. 18. First, the connection control unit 205 receives a data sharing request from the STA 131 by using the communicator 204 (Step S1801). After Step S1801, the connection control unit 205 encrypts the learning data recorded on the storage medium 207. At this time, the connection control unit 205 encrypts data other than the access point type in the learning data for each record by using the security information of the access point of each record (Step S1802).

As described above, when the communicator 204 connects to the access point 121, “AES” may be used as an encryption algorithm and “12345678” may be used as a passphrase. In such a case, the connection control unit 205 encrypts the record corresponding to the access point 121 in the learning data by using the encryption algorithm and the passphrase. After each record is encrypted by using the security information of the access point corresponding to the record, the connection control unit 205 transmits a data sharing response including the encrypted learning data to the STA 131 by using the communicator 204 (Step S1803).

The data sharing response is a packet of the TCP. The IP address of the STA 131 is included in the destination address of the data sharing response. The IP address of the STA 132 is included in the transmission source address of the data sharing response. An identifier representing the data sharing response and the encrypted learning data are included in the data sharing response. For example, all pieces of the learning data accumulated on the storage medium 207 of the STA 132 are included in the data sharing response. When the STA 132 does not possess the learning data, a data sharing response including no learning data is transmitted.

A second example will be described with reference to FIG. 19. First, the connection control unit 205 receives a data sharing request from the STA 131 by using the communicator 204 (Step S1901). After Step S1901, the connection control unit 205 extracts only the record including the access point type of the access point currently connected to by the communicator 204 from the learning data. In other words, the connection control unit 205 extracts only data regarding a service included in the network currently participated in by the communicator 204 from the learning data (Step S1902).

After Step S1902, the connection control unit 205 transmits a data sharing response including the extracted data to the STA 131 by using the communicator 204 (Step S1903). For example, when the communicator 204 currently participates in the network 102, the record including the access point type of the access point 122 of the network 102 is extracted from the learning data. In other words, the record R903 shown in FIG. 9 is extracted and the data sharing response including the record R903 is transmitted to the STA 131. Since the STA 131 and the STA 132 that participate in the same network 102 share information regarding a service on the network 102, encryption is unnecessary.

According to the above-described processing, a plurality of terminals can share the learning data. In the above-described example, when a terminal connects to a network participated in by another terminal, data sharing is performed. Data sharing may be performed when two terminals are physically connected together through another interface different from the communicator 204.

The processing shown in FIG. 15, FIG. 18, and FIG. 19 is independent of the processing shown in FIG. 4 and the like. For this reason, the processing shown in FIG. 15, FIG. 18, and FIG. 19 is not essential.

A communication method according to each aspect of the present invention is based on the operation shown in FIG. 4, FIG. 6, FIG. 10, and FIG. 13. A communication method according to each aspect of the present invention includes an information acquisition step, a determination step, and a communication connection step that use service information (learning data) and are executed by a communication terminal. The service information relates to a service provided by a service providing terminal disposed in each network included in a plurality of networks. The service information includes first information, second information, third information, and fourth information associated with each other. The first information is configured to identify an access point connected to by the communicator 204 at a time of communication for an application 206 to use a service. The second information is configured to identify the application 206. The third information represents an IP address of a service providing terminal. The fourth information is configured to identify a protocol for using a service.

When a service request including use information for using a service is generated from the application 206, fifth information that is configured to identify the application 206, sixth information that represents an IP address, and seventh information that is configured to identify a protocol are acquired on the basis of the use information in the information acquisition step (Step S401). In the determination step (Step S1001), it is determined whether or not the fifth information matches the second information, it is determined whether or not the sixth information matches the third information, and it is determined whether or not the seventh information matches the fourth information. When each of pieces of the information acquired on the basis of the use information matches corresponding information included in the service information, the communicator 204 connects to an access point represented by the first information associated with the second information, the third information, and the fourth information matching the fifth information, the sixth information, and the seventh information, respectively, acquired on the basis of the use information in the communication connection step (Step S1006).

A communication method according to each aspect of the present invention may not include processing other than the processing corresponding to the above-described information acquisition step, determination step, and communication connection step.

As described above, the communicator 204 connects to an access point corresponding to a service requested by the application 206 in accordance with a communication request from the application 206. For this reason, when a service that is able to use the same application is provided in each of a plurality of independent networks, it is possible to access an appropriate access point.

The storage medium 207 stores an encryption key used when the communicator 204 connects to an access point identified by the first information included in service information (learning data). For example, the encryption key is a passphrase. The connection control unit 205 encrypts the service information by using the encryption key in Step S1802. The connection control unit 205 transmits the encrypted service information to an external terminal (STA 131) different from the STA 132 by using the communicator 204 in Step S1803.

In this way, information on a service on a network can be protected from a terminal that is not allowed to connect to an access point, that is, a user that is not allowed to connect to the network. In addition, a terminal that newly participates in a network can connect to the desired access point under the same condition as that in a terminal that has already participated in the network.

When a new service request (communication request) is generated from the application 206 in a state in which the communication connection between a first access point represented by the first information and the communicator 204 is sustained, the connection control unit 205 executes information acquisition processing (Step S401) on the basis of use information included in the new service request. The connection control unit 205 executes determination processing (Step S1001) regarding information acquired on the basis of the use information included in the new service request. When the first access point is different from a second access point represented by the first information associated with the second information, the third information, and the fourth information matching the fifth information, the sixth information, and the seventh information, respectively, acquired on the basis of the use information included in the new service request, the connection control unit 205 disconnects the communication connection between the first access point and the communicator 204 in Step S1102. When each of pieces of the information acquired on the basis of the use information included in the new service request matches corresponding information included in the service information, the connection control unit 205 connects to the second access point by using the communicator 204 in Step S1006 after the communication connection between the first access point and the communicator 204 is disconnected.

A communication terminal uses a certain service on a certain network. After use of the service is completed, a user does not need to change network setting. When a user starts an application different from an application that has been activated, the communicator 204 connects to an access point different from an access point that was connected to last time. Alternatively, for example, when a destination, that is, a uniform resource locator (URL) is changed in order for an application to receive a browser service, the communicator 204 connects to an access point different from an access point that was connected to last time. In this way, the communication terminal can receive a service on another network without a user performing troublesome network setting.

Before communication with a service providing terminal through an access point is started, the connection control unit 205 outputs a temporary response message (temporary response data) for a communication request (service request) to the application 206 in Step S410. After the communication with the service providing terminal through the access point is started, the connection control unit 205 outputs data received from the service providing terminal to the application 206 in Step S315.

In a case where connection processing to an access point requires a lot of time, the connection control unit 205 can eliminate anxiety of a user by informing the user and the application 206 of the current state. In addition, the connection control unit 205 can prevent the application 206 from stopping holding of a communication session.

After the communication with the service providing terminal through the access point is started, the connection control unit 205 acquires a communication result regarding the communication with the service providing terminal in Step S405. When the communication result represents failure of the communication, the connection control unit 205 associates communication result information that represents the communication result with the service information and records the communication result information on the storage medium 207 the in Step S407. When a new service request (communication request) is generated from the application 206, the connection control unit 205 executes information acquisition processing (Step S401) on the basis of use information included in the new service request. The connection control unit 205 executes determination processing (Step S1001) regarding information acquired on the basis of the use information included in the new service request. When there is the service information that includes information matching each of pieces of the information acquired on the basis of the use information and is not associated with the communication result information representing failure (“Error”) of the communication, the connection control unit 205 connects to an access point by using the communicator 204 in Step S1309.

Even when the amount of the service information increases, time required for acquiring a communication result and collation time can be reduced without the communicator 204 performing unnecessary communication.

When the communication result information representing failure of the communication is associated with all of pieces of the service information (learning data) including information matching each of pieces of the information acquired on the basis of the use information, the connection control unit 205 outputs response data that represents that communication is impossible to the application 206 in Step S1311.

In this way, the connection control unit 205 can notify a user and the application 206 that no accessible access point is present and resetting of a network is necessary to the user and the application 206.

When there is no service information (learning data) including information matching each of pieces of the information acquired on the basis of the use information, the connection control unit 205 connects to an access point represented by the first information associated with the second information matching the fifth information and associated with the fourth information matching the seventh information by using the communicator 204 in Step S1011.

After the communication with the service providing terminal through the access point is started, the connection control unit 205 acquires a communication result regarding the communication with the service providing terminal in Step S405. When the communication result represents success (“OK”) of the communication, the connection control unit 205 associates communication result information that represents the communication result with the service information and records the communication result information on the storage medium 207 the in Step S407. When a new service request (communication request) is generated from the application 206, the connection control unit 205 executes information acquisition processing (Step S401) on the basis of use information included in the new service request. The connection control unit 205 executes determination processing (Step S1001) regarding information acquired on the basis of the use information included in the new service request. When there is the service information that includes information matching each of pieces of the information acquired on the basis of the use information and is associated with the communication result information representing success of the communication, the connection control unit 205 connects to an access point by using the communicator 204 in Step S1309.

After the communication terminal experiences the above-described process in a new communication environment, the communication terminal can connect to an appropriate access point and receive the desired service without a user performing troublesome network setting.

While preferred embodiments of the invention have been described and shown above, it should be understood that these are examples of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A communication terminal comprising:
a storage medium;
a communicator; and
a controller,
wherein the storage medium is configured to store service information regarding a service provided by a service providing terminal disposed in each network included in a plurality of networks,
the service information includes first information, second information, third information, and fourth information associated with each other,
the first information is configured to identify an access point connected to by the communicator at a time of communication for an application to use the service,
the second information is configured to identify the application,
the third information represents an IP address of the service providing terminal,
the fourth information is configured to identify a protocol for using the service,
the controller is configured to execute information acquisition processing of acquiring fifth information that is configured to identify the application, sixth information that represents the IP address, and seventh information that is configured to identify the protocol on the basis of the use information when a service request including use information for using the service is generated from the application,
the controller is configured to execute determination processing of determining whether or not the fifth information matches the second information, determining whether or not the sixth information matches the third information, and determining whether or not the seventh information matches the fourth information, and
the controller is configured to connect to the access point represented by the first information associated with the second information, the third information, and the fourth information matching the fifth information, the sixth information, and the seventh information, respectively, acquired on the basis of the use information by using the communicator.

2. The communication terminal according to claim 1,
wherein the storage medium is configured to store an encryption key used when the communicator connects to the access point identified by the first information included in the service information,
the controller is configured to encrypt the service information by using the encryption key, and
the controller is configured to transmit the encrypted service information to an external terminal different from the communication terminal by using the communicator.

3. The communication terminal according to claim 1,
wherein when a new service request including the use information is generated from the application in a state in which communication connection between a first access point represented by the first information and the communicator is sustained, the controller is configured to execute the information acquisition processing on the basis of the use information included in the new service request,
the controller is configured to execute the determination processing regarding information acquired on the basis of the use information included in the new service request,
the controller is configured to disconnect the communication connection between the first access point and the communicator when the first access point is different from a second access point represented by the first information associated with the second information, the third information, and the fourth information matching the fifth information, the sixth information, and the seventh information, respectively, acquired on the basis of the use information included in the new service request, and
when each of pieces of the information acquired on the basis of the use information included in the new service request matches corresponding information included in the service information, the controller is configured to connect to the second access point by using the communicator after the communication connection between the first access point and the communicator is disconnected.

4. The communication terminal according to claim 1,
wherein the controller is configured to output a temporary response data for the service request to the application before communication with the service providing terminal through the access point is started, and
the controller is configured to output data received from the service providing terminal to the application after the communication with the service providing terminal through the access point is started.

5. The communication terminal according to claim 1,
wherein the controller is configured to acquire a communication result regarding communication with the service providing terminal after the communication with the service providing terminal through the access point is started,
the controller is configured to associate communication result information that represents the communication result with the service information and record the communication result information on the storage medium when the communication result represents failure of the communication,
when a new service request including the use information is generated from the application, the controller is configured to execute the information acquisition processing on the basis of the use information included in the new service request,
the controller is configured to execute the determination processing regarding information acquired on the basis of the use information included in the new service request, and
the controller is configured to connect to the access point represented by the first information included in the service information that includes information matching each of pieces of the information acquired on the basis of the use information and is not associated with the communication result information representing failure of the communication by using the communicator.

6. The communication terminal according to claim 5,
wherein the controller is configured to output response data that represents that communication is impossible to the application when the communication result information representing the failure of the communication is associated with all of pieces of the service information including information matching each of pieces of the information acquired on the basis of the use information.

7. The communication terminal according to claim 5,
wherein the controller is configured to connect to the access point represented by the first information associated with the second information matching the fifth information and associated with the fourth information matching the seventh information by using the communicator when there is no service information including information matching each of pieces of the information acquired on the basis of the use information.

8. The communication terminal according to claim 1,
wherein the controller is configured to acquire a communication result regarding communication with the service providing terminal after the communication with the service providing terminal through the access point is started,
the controller is configured to associate communication result information that represents the communication result with the service information and record the communication result information on the storage medium when the communication result represents success of the communication,
when a new service request including the use information is generated from the application, the controller is configured to execute the information acquisition processing on the basis of the use information included in the new service request,
the controller is configured to execute the determination processing regarding information acquired on the basis of the use information included in the new service request, and
the controller is configured to connect to the access point represented by the first information included in the service information that includes information matching each of pieces of the information acquired on the basis of the use information and is associated with the communication result information representing success of the communication by using the communicator.

9. A communication method using service information, the service information relating to a service provided by a service providing terminal disposed in each network included in a plurality of networks, the service information including first information, second information, third information, and fourth information associated with each other, the first information being configured to identify an access point connected to by a communicator at a time of communication for an application to use the service, the second information being configured to identify the application, the third information representing an IP address of the service providing terminal, the fourth information being configured to identify a protocol for using the service, the method comprising:
an information acquisition step causing a controller to acquire fifth information that is configured to identify the application, sixth information that represents the IP address, and seventh information that is configured to identify the protocol on the basis of use information for using the service when a service request including the use information is generated from the application;
a determination step causing the controller to determine whether or not the fifth information matches the second information, determine whether or not the sixth information matches the third information, and determine whether or not the seventh information matches the fourth information; and
a communication connection step causing the communicator to connect to the access point represented by the first information associated with the second information, the third information, and the fourth information matching the fifth information, the sixth information, and the seventh information, respectively, acquired on the basis of the use information.

10. A non-transitory computer-readable recording medium saving a program for causing a computer to use service information, the service information relating to a service provided by a service providing terminal disposed in each network included in a plurality of networks, the service information including first information, second information, third information, and fourth information associated with each other, the first information being configured to identify an access point connected to by a communicator at a time of communication for an application to use the service, the second information being configured to identify the application, the third information representing an IP address of the service providing terminal, the fourth information being configured to identify a protocol for using the service, the program causing the computer to execute:
an information acquisition step of acquiring fifth information that is configured to identify the application, sixth information that represents the IP address, and seventh information that is configured to identify the protocol on the basis of use information for using the service when a service request including the use information is generated from the application;
a determination step of determining whether or not the fifth information matches the second information, determine whether or not the sixth information matches the third information, and determine whether or not the seventh information matches the fourth information; and
a communication connection step of causing the communicator to connect to the access point represented by the first information associated with the second information, the third information, and the fourth information matching the fifth information, the sixth information, and the seventh information, respectively, acquired on the basis of the use information.
